(19) United States
(12) Patent Application Publication
(10) Pub. No.: US 2006/0111919 A1
(43) Pub. Date: May 25, 2006

(54) Computer system and method of outputting beep sound of computer system

(75) Inventor: You Sok Bang, Ansung-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/239,360

(22) Filed: Sep. 30, 2005

(30) Foreign Application Priority Data
Nov. 5, 2004 (KR) 10-2004-0089623

(51) Int. Cl. G10L 21/00; G06F 17/00; G06F 13/24

(52) U.S. Cl. 704/501; 704/504; 700/94; 710/260

(57) ABSTRACT

Embodiments of a computer system and method thereof that can generate a beep sound (e.g., buzzer speaker sound) using an external speaker or the like. The computer system can include a south bridge, a trap handler for trapping beep data when the writing operations of the beep data are performed by ports related to the generation of beep sound of the south bridge, and an audio codec for receiving the beep data trapped by the trap handler to convert the beep data into an audio signal.

### BACKGROUND OF THE INVENTION

This non-provisional application claims priority under 35 U.S.C. §119(a) on patent application No. 10-2004-89623 filed in Korea on Nov. 5, 2004, the entire contents of which are hereby incorporated by reference.

1. Field of the Invention

The present invention relates to a computer system, and more particularly to a computer system and method capable of outputting sound.

2. Background of the Related Art

A beep sound of a computer system is used in various situations. For example, when the power source switch of the computer system is turned on, a BIOS in a BIOS ROM performs a power on self test (POST) routine. At this time, when defects are found in hardware parts of the computer system or essential parts are not mounted in the computer system while the POST routine is performed (e.g., an error is found) a beep sound that is a very simple error signal is output to a buzzer speaker mounted in a main board to inform a user of the error.

FIG. 1 is a block diagram illustrating structure of a related art computer system that outputs the beep sound through the buzzer speaker mounted in the main board in the computer system. As shown in FIG. 1, the related art computer system includes a south bridge 100, an analog codec 120, an amplifier 130, a buzzer speaker 110 and an external speaker port 140.

The south bridge 100 is one of the main chipsets of the main board that are supply sources of the respective data to peripheral equipments. The analog audio codec 120 converts a beep signal and common digital audio signals transmitted from the south bridge 100 into analog audio signals and the amplifier 130 amplifies the audio signals. The buzzer speaker 110 reproduces the predetermined beep sound corresponding to the beep signal transmitted from the amplifier 130, and the external speaker port 140 outputs the amplified digital audio signals to an external speaker (not shown).

The beep sound is output in various situations. The beep sound is output when defects are found in the hardware parts of the computer system, when the essential parts are not mounted in the computer, and when a keyboard is pressed for a long time while the POST routine is performed.

Assuming that the defects are found in the hardware parts of the computer system or that the essential parts are not mounted in the computer system while the POST routine is performed, the process to output the beep sound will now be described. That is, when an error is found while the POST routine is performed, a BIOS (not shown) provides a beep code related to the error to the south bridge 100 that is one of the main chipsets of the main board.

The south bridge 100 is a set of registers that manage the input and output functions of a hard disk and peripheral equipments. The south bridge 100 registers include a plurality of registers, that is, a plurality of ports that store the input and output addresses of auxiliary memories including the hard disk.

The beep code input to the south bridge 100 is output to the buzzer speaker 110 through the analog audio codec 120 and the amplifier 130. Under earlier DOS operation system (O/S) circumstances of the computer system, the above-described buzzer speaker in the main board was used for sound effect of a DOS game or as a substitute for a computer speaker.

However, in the case of a current multimedia computer system, an external high performance speaker for a computer is used. Thus, the buzzer speaker is used only for converting a beep code caused by sensing defects in hardware devices during the POST performed at the initial stage of operation after the power source switch of the computer system is turned on to generate the beep sound.

As described above, the related art computer system and method have various disadvantages. For example, it is not cost effective to mount the buzzer speaker in the main board in the computer system. Also, in the current computer system, an analog audio codec is converted into a digital codec to be applied. Therefore, in order to use the analog beep sound in the digital codec, a new technology is required.

The above references are incorporated by reference herein where appropriate for appropriate teachings of additional or alternative details, features and/or technical background.

### SUMMARY OF THE INVENTION

An object of the invention is to solve at least the above problems and/or disadvantages or to provide at least the advantages described hereinafter.

Another object of the invention is to provide a computer system and method for outputting a beep sound that can solve at least the problems and disadvantages of the background art or to provide at least the advantages described hereinafter.

Another object of the invention is to provide a computer system and method capable of outputting a beep sound through an external speaker.

Another object of the invention is to provide a computer system and method capable of outputting a beep sound used for a buzzer speaker through a standard speaker.

Another object of the invention is to provide a computer system and method capable of outputting a beep sound used for a buzzer speaker in the computer system that uses a digital codec for reproducing high quality digital sound.

Another object of the invention to provide a computer system and method capable of outputting an analog beep sound without mounting an additional device and a buzzer speaker under hardware circumstances of the computer system that does not support the output of the analog beep sound, that is, in the computer system that uses a digital codec for reproducing high quality digital sound.

In order to achieve at least the above objects and described herein described advantages in a whole or in part, in accordance with one aspect of the invention there is provided a computer system that includes a south bridge configured to detect operations at one or more selected ports related to generation of a beep sound and determine an audio value from data trapped during the detected operations and an audio codec configured to generate audio data based on the audio value.

To further achieve at least the above objects and described herein described advantages in a whole or in part, in accordance with one aspect of the invention there is provided a method of outputting beep sound of a computer system that includes initializing a south bridge, initializing a trap handler, generating SMIs in the computer system, determining when SMIs are for at least one port corresponding to generation of a beep sound, performing trap routines to store prescribed data for the at least one corresponding port when selected operations are performed at the at least one corresponding port responsive to the SMIs for the generation of the beep sound and transmitting the prescribed data to an audio codec after the trap routines for the at least one corresponding port is performed.

To further achieve at least the above objects and described herein described advantages in a whole or in part, in accordance with one aspect of the invention there is provided a method of outputting a beep sound of a computer system that includes generating SMIs in the computer system, determining whether an SMI corresponds to a beep sound, trapping predetermined data related to the beep sound when the SMI corresponds to the beep sound and converting the trapped data for audio output.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a block diagram illustrating structure of a related art computer system that outputs beep sound through a buzzer speaker provided in a main board.

FIG. 2 is a block diagram illustrating structure of an embodiment of a computer system that outputs beep sound according to the present invention.

FIG. 3 is a block diagram illustrating the internal structure of a south bridge, which describes exemplary processes of processing a beep signal by the south bridge according to the present invention.

FIG. 4 is a flowchart illustrating an embodiment of a method of outputting the beep sound of the computer system according to the present invention.

FIG. 5 is a flowchart illustrating an embodiment of a trap routine process performed by a 61h port.

FIG. 6 is a flowchart illustrating an embodiment of a trap routine process performed by a 43h port.

FIG. 7 is a flowchart illustrating an embodiment of a trap routine process performed by a 42h port.

FIG. 8 is a flowchart illustrating an exemplary process for transmitting beep data to an audio coder/decoder.

FIG. 9 is a diagram that illustrates exemplary registers.

FIG. 10 is a diagram that illustrates exemplary memory variables.

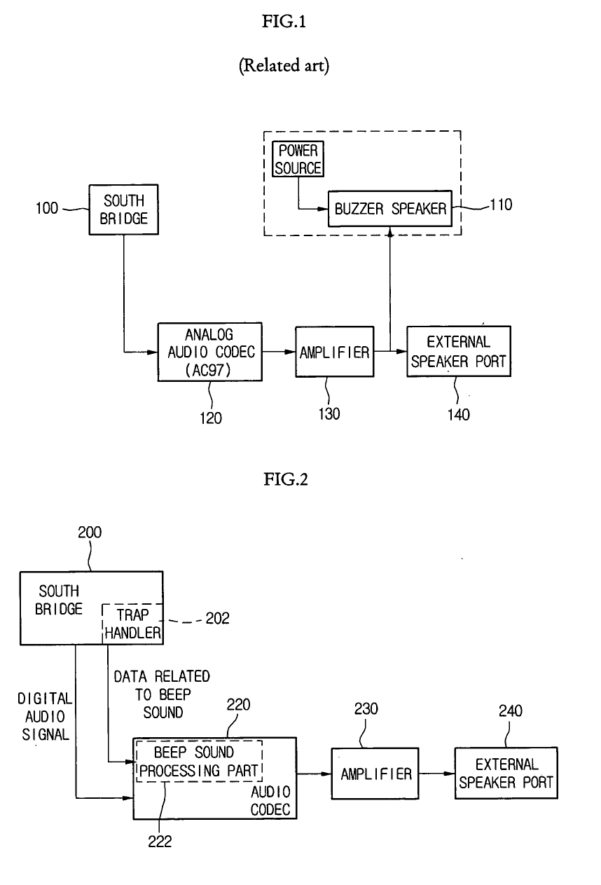

### DETAILED DESCRIPTION OF PREFERRED EMBODIMENTS

FIG. 2 is a block diagram illustrating an embodiment of a computer system that outputs beep sound according to the invention. As illustrated in FIG. 2, the embodiment of the computer system can include a south bride 200, a trap handler 202, an audio codec 220, an amplifier 230 and an external speaker port 240.

The south bridge 200 is preferably one of the main chipsets of a main board that are supply sources of the respective data to peripheral equipments. When selected operations (e.g., writing operations) are performed by predetermined ports related to the generation of the beep sound of the south bridge, the trap handler 202 can detect or determine (e.g., trap) the selected operations. The audio codec 220 can receive beep data trapped by the trap handler 202 to convert the beep data into an analog audio signal, and the amplifier 230 can amplify the audio signal output by the audio codec. The external speaker port 240 can output the amplified audio signal to an external speaker (not shown).

The trap handler 202 can correspond to a specific register provided in the south bridge 200. However, the invention is not intended to be so limited.

At this time, the audio codec 220 can be a digital codec adopted to realize high definition audio through the current computer system. According to embodiments of the invention, it is possible to output the related art analog beep sound without mounting an additional device and a buzzer speaker in the computer system that uses the digital codec for reproducing high quality digital sound.

The south bridge 200 is a set of registers that can manage the input and output functions of a hard disk and peripheral equipments. The south bridge 200 can include a plurality of registers, (e.g., a plurality of ports) that store the input and output addresses of auxiliary memories including the hard disk.

Ports related to the generation of the beep sound of the south bridge 200 can include a 61h port, a 43h port, and/or a 42h port. When writing operations are performed by such ports, the trap handler 202 can perform trapping using system management interrupts (SMI) corresponding to the writing operations.

According to one embodiment, trapping can provide specific conditions for testing in a program that is executed. According to embodiments of the invention, when selected operations (e.g., the writing operations) are performed by the ports related to the generation of the beep sound, the trap handler can sense the SMIs corresponding to the selected operations (e.g., writing operations) to trap the data (e.g., activity) generated by the ports.

As described above, the beep data trapped by the trap handler 202 can be transmitted to the beep sound processing part 222 of the audio codec 220 and converted into an analog audio signal by a beep sound processing part 222. The converted analog audio signal can be finally output through the external speaker (not shown).

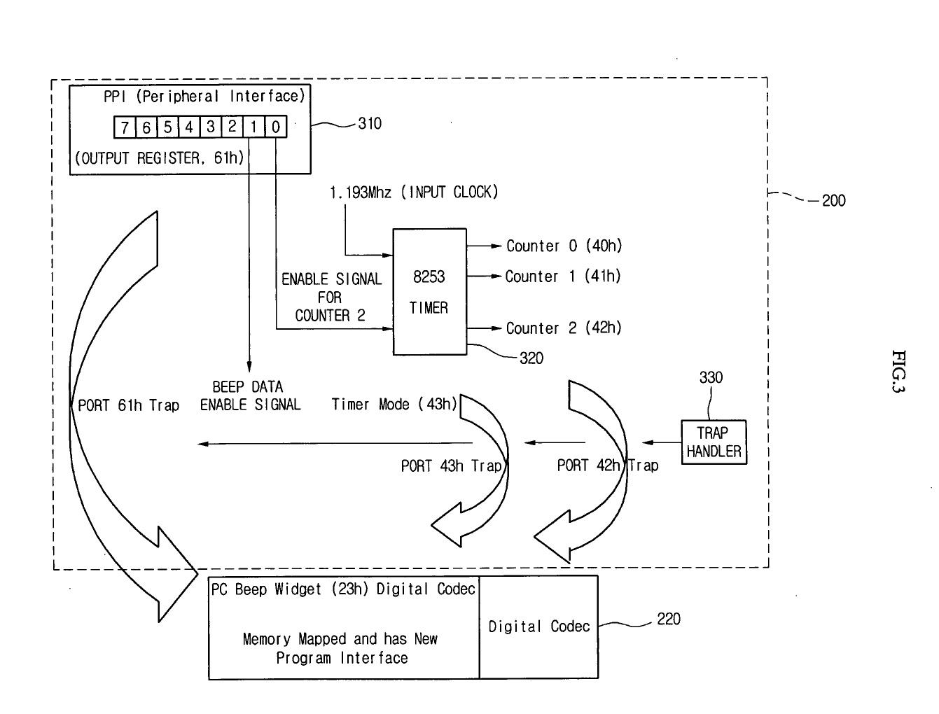

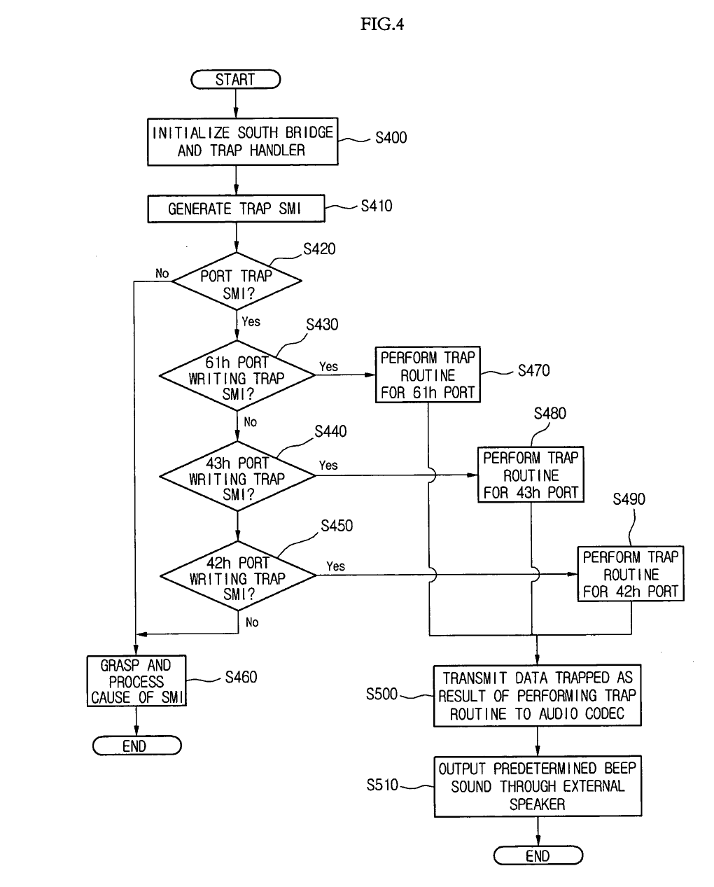

FIG. 3 is a block diagram illustrating an internal structure of the south bridge. Exemplary processes for processing the beep signal by the south bridge according to embodiments of the invention will be described using FIG. 3.

As shown in FIG. 3, the south bridge 200 can include a peripheral interface (PPI) 310 for outputting predetermined beep data from a beep code received from a ROM BIOS, an O/S or the like and a timer 320. The timer 320 can receive the predetermined beep data from the PPI 310 to output a predetermined beep signal corresponding to the beep data.

As shown in FIGS. 3 and 9, the PPI 310 can be matched to the 61h port of the south bridge 200. The 61h[0] can output an enable signal for a counter 2 matched to the beep sound output port (e.g., the 42h port) of the timer. The 61h[1] can output a beep data enable signal. A port can correspond to a register including bits 0-n (e.g., 0-7).

Also, in general, a clock of 1.193 Mhz and the counter 2 enable signal output from the 61h[0] of the PPI 310 can be input to the timer 320. A system timer signal for driving the computer system, a refresh signal of a DRAM, and a beep signal generated by the timer 320 can be respectively output from the counters 0, 1, and 2 of the timer 320.

At this time, the counters 0, 1, and 2 of the timer 320 can be matched to the 40h port, 41h port, and 42h port of the south bridge 200, respectively. A timer mode can be matched to the 43h port.

According to the embodiment of FIG. 2, when the writing operations are performed by the 61h port, 43h port, and 42h port related to the generation of the beep sound among the plurality of ports of the south bridge 200, the trap handler 330 can sense the SMIs corresponding to the writing operations to perform trapping for the corresponding ports.

When the writing operations are performed by the ports related to the generation of the beep sound, for example, the trap handler 330 can sense the SMIs corresponding to the writing operations to trap the data generated by the ports. The data trapped by the trap handler can be transmitted to the audio codec 220 and converted into an analog audio signal for output to the external speaker.

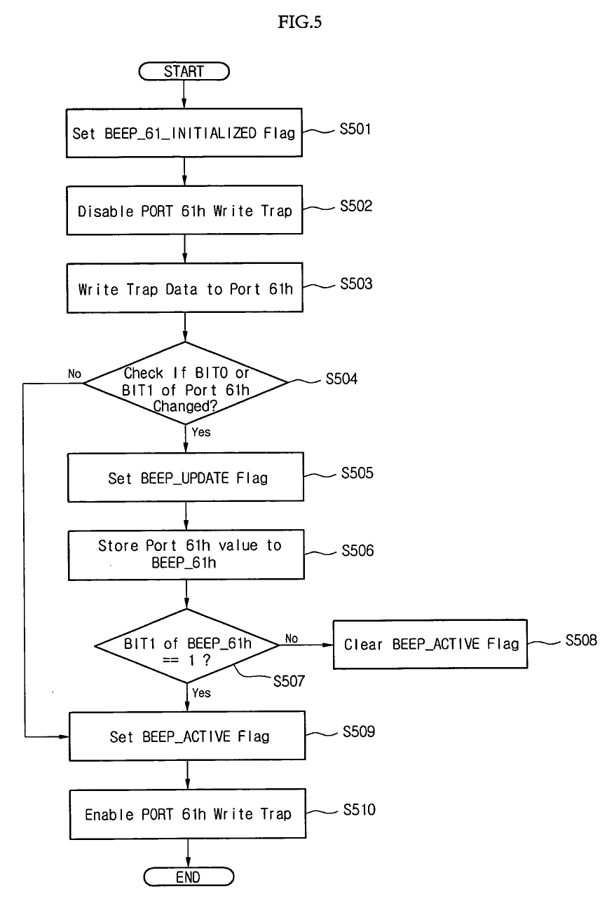

FIG. 4 is a flowchart illustrating an embodiment of a method of outputting the beep sound of the computer system according to the invention. The method shown in FIG. 4 can be applied to and will be described using an embodiment as shown in FIG. 2. However, the invention is not intended to be so limited.

As shown in FIG. 4, a south bridge, a north bridge, and a central processing unit (CPU) can be sequentially initialized in response to the reset signal generated by the application of power to the computer system. The initialized CPU can execute the BIOS to perform the POST so that the state of the computer system is examined and changed.

As the south bridge is initialized, the register corresponding to the trap handler in the south bridge can be initialized (block S400). When the writing operations are performed by predetermined ports of the south bridge that are related to the generation of the beep sound, the trap handler can trap the writing operations.

After the trap handler is initialized, a trap SMI handler for processing the SMIs related to the trapping can be provided in the predetermined ports related to the generation of the beep sound of the south bridge in the trap handler (block S410). When the SMIs are generated in the computer system, it can be determined whether the SMIs are SMIs for the port trapping of the south bridge (block S420).

Here, when the SMIs are for the port trapping (block S420), it can be determined individual ports for which the SMIs are designated. For example, it can be determined whether the SMIs are for the 61h port, 43h port, and 42h port related to the generation of the beep sound (blocks S430, S440, and S450).

When the SMIs are not for the port trapping (block S420) or when the SMIs are not for the 61h port, 43h port, and 42h port related to the generation of the beep sound, the causes of the SMIs can be determined and processes corresponding to the causes can be performed (block S460).

Next, if the SMIs are for the 61h port, 43h port, and 42h port, when the writing operations of the respective ports are performed, the trap handler can sense the SMIs. Thus, the trap handler can perform respective trap routines for the corresponding ports (blocks S470, S480, and S490).

As described above, when the trap routines for the 61h port, 43h port, and 42h port related to the generation of the beep sound are performed, the data generated by the ports can be trapped to be transmitted to the audio codec (block S500). The transmitted generated data can be converted into an analog audio signal by the audio codec to be output through the external speaker (block S510). From block S460 and S510, processes can end (or be repeated).

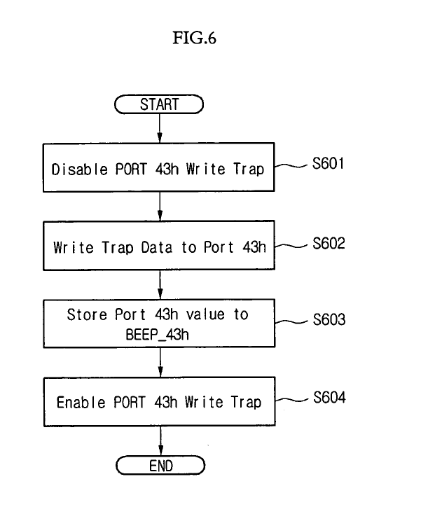

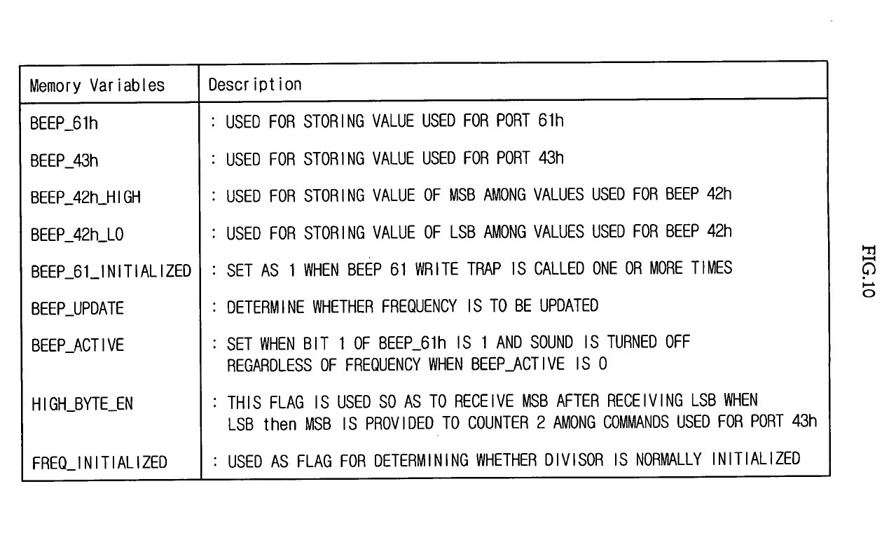

Embodiments of trap routine process performed by the respective ports, for example, the 61h port, 43h port, and 42h port will be described with reference to FIGS. 5 to 7. FIGS. 9 and 10 illustrate exemplary registers and memory variables that can be used or applied to embodiments of the present invention. However, the invention is not intended to be so limited.

FIG. 5 is a flowchart illustrating an embodiment of a trap routine process using the 61h port. The embodiment of the trap routine process of FIG. 5 can be applied to block S470 in FIG. 4. However, the invention is not intended to be so limited.

As shown in FIG. 4, when the writing operation is performed by the 61h port and the SMI for the writing operation is sensed by the trap handler, a trap routine can be started by the 61h port.

According to embodiments of the invention, input and output (I/O) and reading and writing can be reduced or minimized, and routines can be simply designed so that sound to be originally generated is generated as it is. Therefore, various exemplary memory variables illustrated in FIG. 10 can be used. However, the invention is not intended to be so limited.

For example, it is possible to overcome delay and distortion of sound that can be generated when I/O and reading and writing are complicated. In this case, such problems can be reduced or avoided using the memory variables.

As shown in FIG. 5, when the trap routine for the 61h port starts, the memory variable BEEP_{—}61_INITIALIZED flag can be set as 1. Thus, the variable can be set to a prescribed value (block S501).

The memory variable BEEP_{—}61_INITIALIZED can be set as 1 when the trapping for the 61h port is called one or more times. Next, the writing trapping of the 61h port can be disabled so that the SMI event is not generated during the time that the trap handler for the 61h port is processed (block S502).

Then, the value to be used for the 61h port when the trapping is generated can be used for the 61h port. That is, the writing operation that is a cause of the generation of the trapping was actually cancelled, and when the value to be used for the 61h port in the above step is provided, the value can be actually used for the 61h port (block S503).

Then, it can be determined whether the signals output from the 61h[0] and 61h[1], that is, an enable signal (e.g., timer counter 2 enable) and a beep data enable signal (e.g., speaker data enable) for the counter 2 are changed (block S504).

When it is determined that the signals are changed, a memory variable BEEP_UPDATE flag can be set to a prescribed value such as 1 (block S505). Here, the memory variable BEEP_UPDATE can determine whether a frequency is to be updated.

Next, since the 61h port was changed, a memory variable BEEP_{—}61h can be changed into a newly written used value (block S506). Here, the memory variable BEEP_{—}61h can be used for storing the value used for the 61h port.

Next, it is determined whether the beep data enable signal (e.g., speaker data enable) is enabled (block S507). A memory variable BEEP_ACTIVE can be set to a preset value such as 1 when the beep data enable signal is enabled and cleared (e.g., to 0) when the beep data enable signal is not enabled (block S508 and S509).

The memory variable BEEP_ACTIVE can be set when the bit of the memory variable BEEP_{—}61h is 1 (e.g., when the 61h[1] is 1). When the memory variable BEEP_ACTIVE is 0, sound can be turned off regardless of the frequency.

Then, the writing trapping of the 61h port that was disabled can be enabled (block S510). The trap routine can then be completed.

A trap routine for the 61h port can be performed through the above-described process. However, the invention is not intended to be so limited. The result obtained by performing the trap routine can be transmitted to the audio codec so that predetermined beep sound can be output through the external speaker.

FIG. 6 is a flowchart illustrating an embodiment of the trap routine process performed by the 43h port. The embodiment of the trap routine process of FIG. 6 can be applied to block S480 in FIG. 4. However, the invention is not intended to be so limited.

As shown in FIG. 4, the writing operation for the 43h port is performed and the SMI for the writing operation is sensed by the trap handler. Accordingly, the trap routine for the 43h port can begin.

Also, since the trapping of the 42h port is preferably meaningful only after the trap routine for the 43h port is performed, important clues for determining whether a divisor is to be used for the counter 2 of the timer illustrated in FIG. 3 can be obtained from the trap routine for the 43h port.

As shown in FIG. 6, the writing trapping for the 43h port can be disabled (block S601). Then, the value to be used for the 43h port when the trapping is generated can be used for the 43h port. For example, the writing operation that is a cause of the generation of the trapping was actually cancelled, and when the value to be used for the 43h port in the above step is provided, the value can be actually used for the 43h port (block S602).

Next, in order to refer to the value used for the 43h port, the value can be stored in a memory variable BEEP_{—}43h (block S603). However, the invention is not intended to be so limited.

Next, the writing trap of the 43h port that was disabled can be enabled (block S604). Then, the trap routine can be completed.

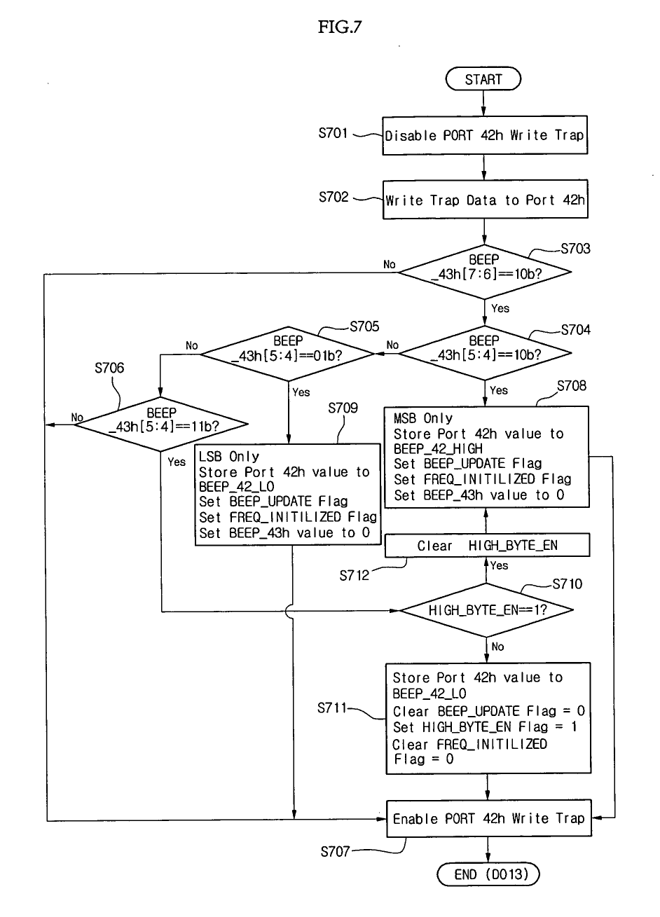

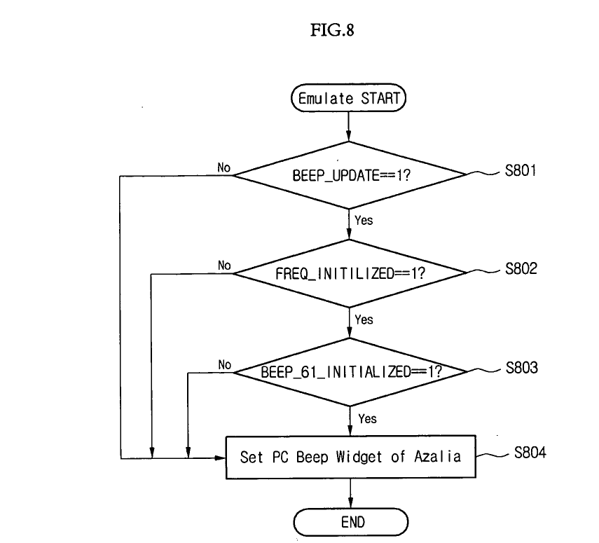

FIG. 7 is a flowchart illustrating an embodiment of the trap routine process performed by the 42h port. The embodiment of the trap routine process of FIG. 7 can be applied to block S490 in FIG. 4. However, the invention is not intended to be so limited.

As shown in FIG. 4, the writing operation for the 42h port is performed and the SMI for the writing operation can be sensed by the trap handler. Accordingly, as shown in FIG. 7, a trap routine for the 42h port can start.

First, the writing trapping for the 42h port can be disabled (block S701). Then, the value to be used for the 42h port can be used for the 42h port (block S702). For example, the writing operation that is a cause of the generation of the trapping was actually cancelled, and when the value to be used for the 42h port in the above process is provided, the value can be actually used for the 42h port.

It can be determined whether the writing operation is for the counter 2 of the timer with reference to the memory variable BEEP_{—}43h described with reference to FIG. 6 (block S703). Then, it can be determined whether the value to be used for the 42h port is the value to be used as the most significant bit (MSB) (block S704). Next, it can be determined whether the value to be used for the 42h port is the value to be used for the least significant bit (LSB) (block S705).

Further, it can be determined whether the value to be used for the 42h port is executed by a command LSB then MSB (block S706). In this case, it is preferably necessary to additionally determine whether the value is to be used as the LSB or the MSB.

Otherwise (block S706), the value to be used is preferably not the value to be used for the counter 2 of the timer. In this case, the writing trapping of the 42h port can be enabled (block S707).

When the value to be used for the 42h port is the value to be used for the MSB (block S704), the value to be used for the 42h port can be stored in a memory variable BEEP_{—}42h_HIGH.

It is preferably determined that the memory variable BEEP_UPDATE=1, a memory variable beep initialized FREQ_INITIALIZED=1, and the memory variable BEEP_{—}43h=0. Here, the memory variable BEEP_UPDATE can be a factor for determining whether the frequency is to be updated. Then, since the operation of providing command to the 43h port is completed, the value of the memory variable BEEP_{—}43h can be cleared (block S708).

When the value to be used for the 42h port is the value to be used as the LSB (block S705), the value to be used for the 42h port can be stored in a memory variable BEEP_{—}42h_LO. It is preferably determined that the memory variable BEEP_UPDATE=1 and the memory variable beep initialized FREQ_INITIALIZED=1 (block S709).

A divisor can be determined by the memory variables BEEP_{—}42h_HIGH and BEEP_{—}42h_LO. Further, the frequency can be determined by the divisor.

It can be determined whether a memory variable HIGH_BYTE_EN is set as 1. For example, when the command LSB then MSB is provided to the 43h port, it can be determined whether the LSB or the MSB must be processed (block S710).

When HIGH_BYTE_EN=1 in block S710, since the MSB is received, the memory variable HIGH_BYTE_EN can be cleared (step S712).

When the memory variable HIGH_BYTE_EN is 0, since the command LSB then MSB is used for the PORT 43h, and then, the value is used for the 42h port, the LSB must be processed.

When the command LSB then MSB is provided to the counter 2 of the memory among the commands used for the 43h port, the memory variable HIGH_BYTE_EN preferably uses the flag so as to receive the MSB after receiving the LSB.

The value to be used for the 42h port can be stored in the memory variable BEEP_{—}42h_LO and the flag can be set as follows. Since the divisor is being updated, the memory variable BEEP_UPDATE flag is cleared to 0 and a memory variable FREQ_INITIALIZED flag is cleared to 0. Here, the memory variable FREQ_INITIALIZED can be used as the flag for determining whether the divisor is normally initialized. Also, in order to inform that the MSB must be received, the memory variable HIGH_BYTE_EN flag can be set as 1 (block S711).

Then, the writing trapping for the 42h port is preferably completed (S707).

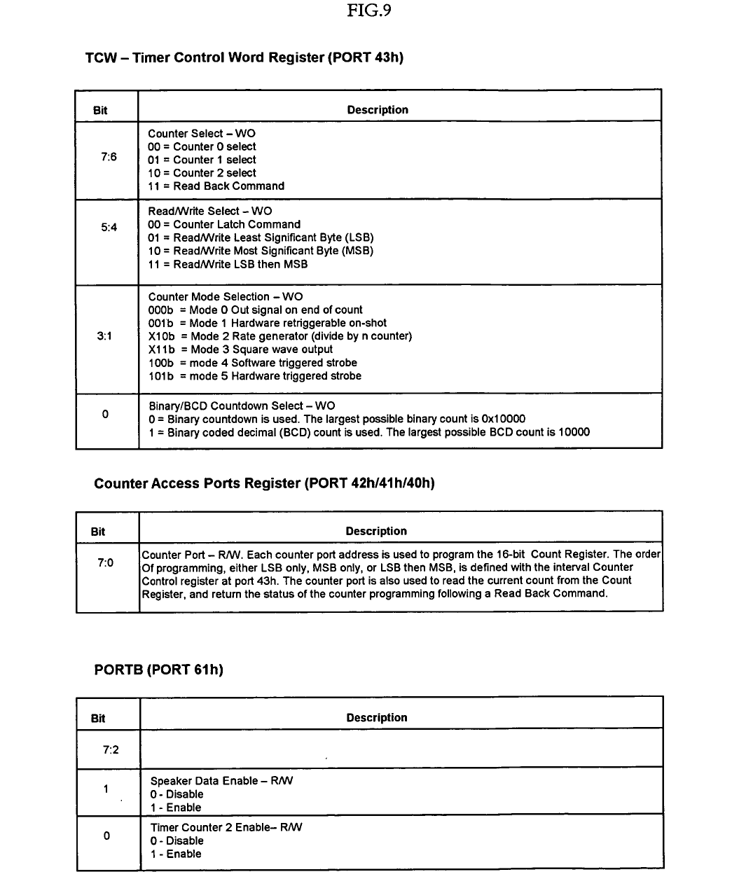

FIG. 8 is a flowchart illustrating an exemplary process to transmit a result obtained by performing trap routine(s) for output (e.g., to an audio codec). The exemplary process of FIG. 8 can be applied to block S500 in FIG. 5. However, the invention is not intended to be so limited.

As shown in FIG. 8, the analog beep sound starts to be emulated using the information obtained from selected ports of the south bridge. As described above, ports can include the 61h port, 42h port, and 43h port.

First, it can be determined whether the beep sound must be updated (block S801). Then, it can be determined whether the frequency is initialized (S802).

That the frequency is initialized preferably means that the memory variables used to calculate a frequency are updated and the frequency can be calculated using a prescribed equation. For example, the memory variable BEEP_{—}42h_HIGH and BEEP_{—}42h_LO that can determine a divisor are initialized and the frequency can be calculated as illustrated in EQUATION 1.

$$frequency = \frac{1 \text{,} 193 \text{,} 180 hz}{divisor} \qquad [ EQUATION 1 ]$$

(Divisor=BEEP_{—}42h_HIGH*256+BEEP_{—}42h_LO)

Then, it can be determined whether an application program approaches the 61h port in order to generate the beep sound. That it, it can be determined whether a memory variable BEEP_{—}61_INITIALIZED is set as 1 (block S803).

Thus, the divisor can be initialized and it can be determined whether the beep sound is to be output or not to be output in accordance with the memory variable BEEP_ACTIVE. Since the beep sound must be updated, the analog beep sound must be emulated using hardware that can generate sound.

At this time, methods of generating the beep sound may vary with hardware design and a method appropriate for the design should be selected.

According to embodiments of the invention, a method of obtaining payload based on frequency information of the PC beep widget of the digital codec to generate sound may be used. On the other hand, the relationship between the payload and the frequency can be as illustrated in EQUATION 2.

$$frequency = \frac{48 khz}{( 4 \times payload )} \qquad [ EQUATION 2 ]$$

Therefore, the relationship between the payload and the divisor can be as illustrated in EQUATION 3.

$$payload = divisor \times \frac{48 khz}{( 4 \times 1 \text{,} 190 \text{,} 000 hz )} = \frac{divisor}{99.166} \qquad [ EQUATION 3 ]$$

As described above, when the payload value is obtained using the divisor value and the payload value is used for the PC beep widget of the digital codec, it is possible to obtain analog PC beep.

Therefore, one exemplary approach to hardware for outputting the beep sound can be completed (block S804). The audio codec can be an Azalia codec.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of a computer system and methods thereof have various advantages. For example, embodiments of a computer system and method thereof that can generate a beep sound (e.g., buzzer speaker sound) using an external speaker or the like. Further, costs can be reduced or additional hardware can be removed.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A computer system, comprising:
a south bridge configured to detect operations at one or more selected ports related to generation of a beep sound and determine an audio value from data trapped during the detected operations; and
an audio codec configured to generate audio data based on the audio value.

2. The computer system of claim 1, comprising:
a trap handler configured to trap beep data when writing operations of the beep data are performed by the selected ports related to the generation of the beep sound of the south bridge; and
a memory coupled to the trap handler and configured to store the trapped beep data.

3. The computer system of claim 2, wherein the trap handler comprises a register in the south bridge.

4. The computer system of claim 2, wherein when the writing operations are performed by the selected ports, the trap handler is configured to sense system management interrupts (SMI) to perform trapping for corresponding ports.

5. The computer system of claim 1, wherein the selected ports related to the generation of the beep sound of the south bridge include a 61h port, a 43h port or a 42h port.

6. The computer system of claim 1, wherein the south bridge comprises:
a peripheral interface (PPI) configured to output predetermined beep data from a received beep code; and
a timer configured to receive the predetermined beep data from the PPI to output a predetermined beep signal corresponding to the predetermined beep data.

7. The computer system of claim 6, wherein the PPI is matched to a 61h port of the south bridge, wherein the 61h port outputs an enable signal for a counter matched to an output port of the beep sound of the timer when a first bit of the 61h port is a first level, and
wherein the 61h port outputs a beep data enable signal when a second bit of the 61h port is a second level.

8. The computer system of claim 6, wherein a system timer signal configured to drive the computer system, a refresh signal of a DRAM, and the predetermined beep signal are output from first, second and third output counters of the timer, respectively.

9. The computer system of claim 8, wherein the first, second and third counters of the timer are respectively matched to a 40h port, a 41h port, and a 42h port of a south bridge, and
wherein a timer mode is matched to a 43h port.

10. The computer system of claim 1, comprising:
a speaker coupled to the audio codec configured to output a generated beep sound.

11. A method of outputting beep sound of a computer system, the method comprising:
initializing a south bridge;
initializing a trap handler;
generating SMIs in the computer system;
determining when SMIs are for at least one port corresponding to generation of a beep sound;
performing trap routines to store prescribed data for said at least one corresponding port when selected operations are performed at said at least one corresponding port responsive to the SMIs for the generation of the beep sound; and
transmitting the prescribed data to an audio codec after the trap routines for said at least one corresponding port is performed.

12. The method of claim 11, wherein the beep sound is for buzzer speaker.

13. The method of claim 11, wherein the trap handler is in the south bridge.

14. The method of claim 13, further comprising providing a trap SMI handler for processing the SMIs for said at least one corresponding port in the trap handler after initializing the trap handler, and wherein said at least one corresponding port of the south bridge related to the generation of the beep sound includes a 61h port, a 43h port or a 42h port.

15. The method of claim 11, wherein the trap handler corresponds to a specific register included in the south bridge.

16. The method of claim 11, wherein the SMIs for said at least one corresponding port are for writing operations.

17. A method of outputting a beep sound of a computer system, the method comprising:
generating SMIs in the computer system;
determining whether an SMI corresponds to a beep sound;
trapping predetermined data related to the beep sound when the SMI corresponds to the beep sound; and
converting the trapped data for audio output.

18. The method of claim 17, wherein the trapped data is converted into an audio signal, further comprising:
amplifying the audio signal; and
outputting the audio signal using a speaker.

19. The method of claim 17, wherein the trapping the predetermined data comprises storing beep data generated by ports related to the beep sound of a south bridge.
